(19) United States
(12) Patent Application Publication
(10) Pub. No.: US 2020/0320892 A1
(43) Pub. Date: Oct. 8, 2020

(54) SYSTEM AND PROCESS USING AN ESTIMATOR GAME FOR HABITUATING COMPLEX LEARNING PATTERNS

(71) Applicant: Donalee Markus, Highland Park, IL (US)

(72) Inventor: Donalee Markus, Highland Park, IL (US)

(21) Appl. No.: 16/375,261

(22) Filed: Apr. 4, 2019

(51) Int. Cl. G09B 5/02; G06F 3/0484; G06F 3/0488; G09B 19/02

(52) U.S. Cl. CPC G09B 5/02; G09B 19/025; G06F 3/04886; G06F 3/04847

(57) ABSTRACT

A system and method provides an estimator game on a computing device for habituating complex learning processes, wherein the estimator game displays a source image on the computing device, and the computing system analyzes a particular image aspect of the visual image such as the percentage area of the visual image comprising a distinctive color, for example, the color black. The system includes an estimator module allowing the user to view and evaluate the image and subjectively enter an estimate associated with the image aspect. The estimation data is entered by the user, and stored by the processor in an associated computer readable memory, and then the estimation process is repeated with the user. The computing system runs the user through multiple image evaluations before providing performance feedback, wherein the estimator game generates feedback to the user in clusters or image sets. This allows the user to complete multiple iterations without feedback, and when the feedback is provided, the user can better recognize learning errors and patterns in order to build new skills. Without the awareness of when and where the user makes errors, the mistakes cannot be corrected to build expertise. The estimator game provides opportunities for further rehearsal after this detailed feedback including the opportunity to increase complexity by increasing variables or ambiguities associated with the images. As a result, the inventive system incorporates self-observation and pattern recognition by the user, which is critical to building any expertise.

### FIELD OF THE INVENTION

This invention relates to a method and system incorporating a visual estimator game for improving complex learning patterns, and more particularly to such system and method wherein the visual estimator game allows a user to repetitively rehearse numeric estimation of at least one aspect of the visual imagery to improve estimation skills and habituate complex learning processes. The estimator game runs the user through multiple image evaluations before providing performance feedback to the user in clusters or image sets, wherein the user completes multiple iterations without feedback so that the user can better recognize learning errors and patterns in order to build new skills. This provides the user with the awareness of when and where the user makes errors, and the mistakes can be corrected to build expertise. The estimator game provides opportunities for further rehearsal after this detailed feedback including the opportunity to increase complexity by increasing variables or ambiguities associated with the images. As a result, the inventive system incorporates self-observation and pattern recognition by the user, which is critical to building any expertise.

### BACKGROUND OF THE INVENTION

Mathematicians use rules to structure their thoughts, but they also explore their thoughts from every possible perspective. Through visual processing, math-oriented individuals manipulate images in their minds. They determine, based on a specific goal, which details are relevant and which are not to solve the problem. Mathematicians use their visual systems consciously and intentionally to organize information and to generate alternatives to complex problems. The study of math is critical for learning to think in a logical, orderly way about the relationship between things in the past, the present, and the future. Even more directly, math is a precise way of evaluating visual images.

Visual imagery, which is the foundation of abstract thinking and mathematics, relates to an individual's ability to evaluate visual information using mental processes. The imaged picture may enable the individual to “see” relationships and to link these relationships to other ideas. Therefore, visual imagery is also the essence of creativity and discovery.

Traditional training programs teach math through rules and practice problems, thus reinforcing the concept that mathematical thinking is a verbal process. Most recipients of this traditional training are not able to remember or to apply math to real life situations.

In one known invention disclosed in U.S. Pat. No. 9,649,555 B2, puzzle games were provided for developing and strengthening an individual's visual imagery and cognitive skills. To solve these puzzles, the individual used visual imagery to compare, contrast, rotate and reflect parts of a whole image to create a new image in the form of a kaleidoscope. Therefore, the puzzle games used kaleidoscope images that allowed an individual to rehearse and to habituate the cognitive processes necessary for complex decision making and mathematics. The kaleidoscope puzzles also provided individuals who have weak, underdeveloped, or lost visual imagery the opportunities to develop or redevelop such skills.

It is an objective of the invention to therefore provide an effective system and process for habituating complex learning processes through the incorporation of visual estimator software to develop estimation skills.

The invention relates to a system and method that uses an estimator game for habituating complex learning processes, wherein the estimator game displays a source image on the computing device. The user is able to view the source image having a particular image aspect or characteristic, such as specific colors, wherein the area of the colors can be estimated. By displaying the image to the user, the user can develop their own numeric estimates of the image aspect and upon entering the estimate into the estimation game, the user eventually obtains performance results from the inventive system after viewing a number of images. The process of generating these estimates and receiving performance feedback allows the user to improve their estimation skills which ultimately improves their cognitive ability to perform complex processes. Generally, estimation is a process that is used constantly by mathematically capable adults. According to the Common Core State Standards (2010), by the second grade, students should be introduced to estimation and attain the ability to measure and estimate lengths in standard units. Estimation involves an educated guess about a quantity or a measure, or an intelligent prediction of the outcome of a computation. The growing use of calculators makes it more important than ever that individuals know when a computed answer is reasonable. Estimation can be defined as the process of determining approximate values in a variety of situations. Estimation strategies are used universally throughout daily life. People who use mathematics in their lives and careers find estimation to be preferable to the use of exact numbers in many circumstances. Frequently, it is either impossible to obtain exact answers or too expensive to do so. As such, development of estimation skills through the inventive system and method also improves an individual's complex learning processes.

More specifically as the invention, the computing device includes a store of multiple different images, which are of the type having one or more visual aspects which can be readily recognized and numerically quantified by the computing system. One visual aspect may be the amount of a particular color in an image. In this preferred embodiment, the computer system analyzes or processes each image to quantify the visual aspect being evaluated. The computer may identify and process the percentage area of the image comprising a distinctive color, for example, the color black, in comparison to the total area of that visual image. The processor performs an analysis for each image and stores calculated image data resulting from such analysis for subsequent comparison with estimation data input by the user. When the user uses the estimator game, the computing system generates a subset of the images for display to the user. The computing system includes several operating modes to select and then present or visually display the set of selected images, one at a time, to a user for analysis and estimation of the visual aspect(s) being evaluated.

The system includes a processor for analyzing the image relative to the visual aspect being evaluated and to calculate the image data associated with that visual aspect. The system further includes an estimator module allowing the user to view and evaluate the same image and subjectively enter a personal estimate associated with the visual aspect. An estimate is entered by the user as estimation data, and stored by the processor in an associated computer readable memory for subsequent analysis. The estimation process is then repeated wherein the user enters estimation date or an estimate for each image of the training set before the system outputs results or performance feedback for the user. The system repeats the estimator procedure several times before providing performance feedback to the user. The system thereby displays feedback indicating the correctness of the estimate and/or degree of deviation of the personal estimate from the calculated image data for the visual aspect being estimated. Repetitive training with this estimator helps the user to habituate complex learning patterns.

The estimator game has a carefully designed systematic approach to achieve habituation of these complex learning patterns. The estimator game also provides for additional features to further facilitate the training process. The estimator game is hierarchically organized to build complexity both vertically and laterally, wherein vertical complexity is developed with an increase of the number of variables needed to solve the problem or generate the estimate, and lateral complexity involves the concept of increased ambiguity.

The inventive system and process incorporates deliberate rehearsal into the estimator game. Deliberate rehearsal is systematic practice, which demands attention, awareness, and the meaning of a specific goal. As such, the individual must give their attention to the estimator puzzle, and since the inventive system and process improves complex learning processes, there is meaning to the exercise that goes beyond completing the problem. Rather, there is intention to solving the puzzle with a purpose beyond just data entry wherein the user develops attention to the process itself so that the user enhances their thinking, processing, time management, and data calculation skills and learns from their mistakes. Deliberate rehearsal enables the individual to transfer their improved skills to other domains and tasks beyond data estimation.

As noted above, the computing system runs the user through multiple image evaluations before providing performance feedback, wherein the estimator game generates feedback to the user in clusters or image sets. For example, the training set may include five (5) images, and the system may not generate feedback until the user has completed five experiences with the specific skill. This allows the user to complete multiple iterations without feedback, and when the feedback is provided, the user can better recognize learning errors and patterns in order to build new skills. Without the awareness of when and where the user makes errors, the mistakes cannot be corrected to build expertise. The estimator game provides opportunities for further rehearsal after this detailed feedback including the opportunity to increase complexity by increasing variables or ambiguities associated with the images. As a result, the inventive system incorporates self-observation and pattern recognition by the user, which is critical to building any expertise. Further, randomized selection of images by the system and presentation of the images with a variety of visual modifiers such as different sized grids provides thousands of different opportunities to rehearse estimating at different skill levels, i.e. beginning intermediate, advanced and expert.

The system and process of the present invention provides significant advantages in enhancing complex processing skills. In effect, the estimator program incorporates the rehearsal of visual imagery analysis, which ultimately habituates estimation skills to everyday living. In effect, rehearsal builds habituation, or in other words, repetition of skills, particularly when they become increasingly more challenging helps to build improved processing habits. At its most basic level, the estimation game teaches the user to identify the relationship of part-to-whole, which translates into improved estimation skills. In a larger sense, these improved skills improve the development of metacognitive thinking and problem-solving skills.

The estimation game also includes additional features to increase or at least vary the complexity and analysis of the visual imagery being displayed. In one embodiment, a grid may be provided which overlies the image and reorganizes the presentation of the image. By utilizing the grid system of reorganization, this feature will lead to habituating behaviors, such as for time management, planning, and budgeting and lead to a greater understanding of visualizing parts to a whole. Further the grid configuration may be changed in size and arrangement such as the sizes of boxes making up the grid. This changing of the boxes or grid is one example of a reorganization of images, which may then change the estimation process and enhance user skills when viewing the same picture with different grid organizations.

The inventive system and process allows particular training with the estimator software, which is expected to improve other daily living skills. For example, at the subconscious level, the system allows an individual to transfer their ability to estimate to other areas including spending money, planning behavior, and time management which all include some aspect of estimation whether it relates to expenses, complexity or time.

The estimator thereby provides individual opportunities for rehearsal of various skills at many different levels of difficulty. First visual imagery relates to the ability to create, hold and manipulate images in their head, which are foundational skills. Analytical perception is another skill which relates to a person's ability to recognize part-to-whole relationships and see the big picture and pieces of the whole. Further, math fluency is a skill that relates to the ability to add, subtract, multiply, divide and understand fractions and decimals.

As such, the inventive system and process provides the opportunity to manipulate images and sort the images in many different ways, which is believed to be an inventive way to habituate complex process. The variations and the sorting of the images gives a concrete example of not only the answer to estimation problems, but the process used to get the answer. The estimator game encourages the participant to focus on the process, which the user can then replicate or generalize to other situations. There are thousands of opportunities for rehearsal within the system disclosed herein.

In particular, the inventive system uses hierarchically organized graphics to estimate the amount of black in the image, which gives an individual the opportunity to generalize the skills to a totally different domain. In order to solve the estimator problems in the graphic sections, the individual or user must manipulate bits and pieces of the puzzle and compare it to the whole.

Other objectives and purposes of the invention, and variations thereof, will be apparent upon reading the following specification and inspecting the accompanying drawings.

### BRIEF DESCRIPTION OF THE DRAWINGS

FIG. 1 is a perspective view of a computing device operating an estimator game or software application on a display or GUI of the present system, wherein the Home Page view is shown with available image estimation units or modules labelled as Grids, Illustrations, Photos and Your Own Photos.

FIG. 2 is an exemplary screenshot for the GUI of the present system showing the Grids view with a first visual image of the Grids image type having a first grid configuration displayed thereon.

FIG. 3 is an exemplary screenshot for the GUI of the present system showing entry of estimation data for several visual aspects of the first image.

FIG. 4 is an exemplary screenshot for the GUI of the present system showing the image of FIG. 3 as the estimation process continues with the user's hand shifted to the next slider of the game.

FIG. 5 is an exemplary screenshot for the GUI of the present system showing the image of FIG. 3 as the estimation process is completed for the first image.

FIG. 6 is an exemplary screenshot for the GUI of the present system showing an alternate data entry option for entering estimation date using a number pad.

FIG. 7 is another exemplary screenshot for the GUI of the present system showing the estimation data as the estimation process of FIG. 6 continues with the number pad.

FIG. 8 is another exemplary screenshot for the GUI of the present system showing changing of the grid configuration to a second grid configuration having a smaller size which gives the user a different experience with the same problem using a different visual configuration.

FIG. 9 is an exemplary screenshot for the GUI of the present system showing the Grids view of the first image with a third grid configuration.

FIG. 10 is an exemplary screenshot for the GUI of the present system showing the Grids view of the first image with a fourth grid configuration.

FIG. 11 is an exemplary screenshot for the GUI of the present system showing the Grids view of the first image with a fifth grid configuration larger than the first to fourth grid configurations.

FIG. 12 is an exemplary screenshot for the GUI of the present system showing the Grids view with the color blocks of the first image shuffled to a second image configuration in combination with the second grid configuration.

FIG. 13 is an exemplary screenshot for the GUI of the present system showing the Grids view with the color blocks reshuffled to a third image configuration.

FIG. 14 is an exemplary screenshot for the GUI of the present system showing the Grids view with the color blocks sorted together in a different image configuration using the same number of color blocks.

FIG. 15 is another exemplary screenshot for the GUI of the present system showing the Grids view after completion of data entry for each image in an image set in the Grids module.

FIG. 16 is another exemplary screenshot for the GUI of the present system showing the Puzzle Summary or Results view after completion of data entry for each image in an image set and showing the estimation data and comparative results data.

FIG. 17 is an exemplary screenshot for the GUI of the present system showing the Illustrations view with a first visual image from this Illustrations image type having a first grid configuration displayed thereon.

FIG. 18 is an exemplary screenshot for the GUI of the present system showing the Illustrations view with the first visual image from this image type having a second grid configuration displayed thereon, wherein the second grid configuration is smaller to give the user another experience with mathematical concepts.

FIG. 19 is an exemplary screenshot for the GUI of the present system showing the Illustrations view with the first visual image changed to a second visual image from this Illustrations image type having a third grid configuration displayed thereon.

FIG. 20 is an exemplary screenshot for the GUI of the present system showing the Photos view with a first visual image from this Photos image type having the first grid configuration displayed thereon.

FIG. 21 is an exemplary screenshot for the GUI of the present system showing the Puzzle Summary or Results view in the Photos module after completion of data entry for each image in a test set and showing the estimation data without the comparative results data.

FIG. 22 is an exemplary screenshot for the GUI of the present system showing the selection screen for the Your Own Photos view with images omitted from the image selection spaces.

Certain terminology will be used in the following description for convenience and reference only, and will not be limiting. For example, the words “upwardly”, “downwardly”, “rightwardly” and “leftwardly” will refer to directions in the drawings to which reference is made. The words “inwardly” and “outwardly” will refer to directions toward and away from, respectively, the geometric center of the arrangement and designated parts thereof. Said terminology will include the words specifically mentioned, derivatives thereof, and words of similar import.

### DETAILED DESCRIPTION

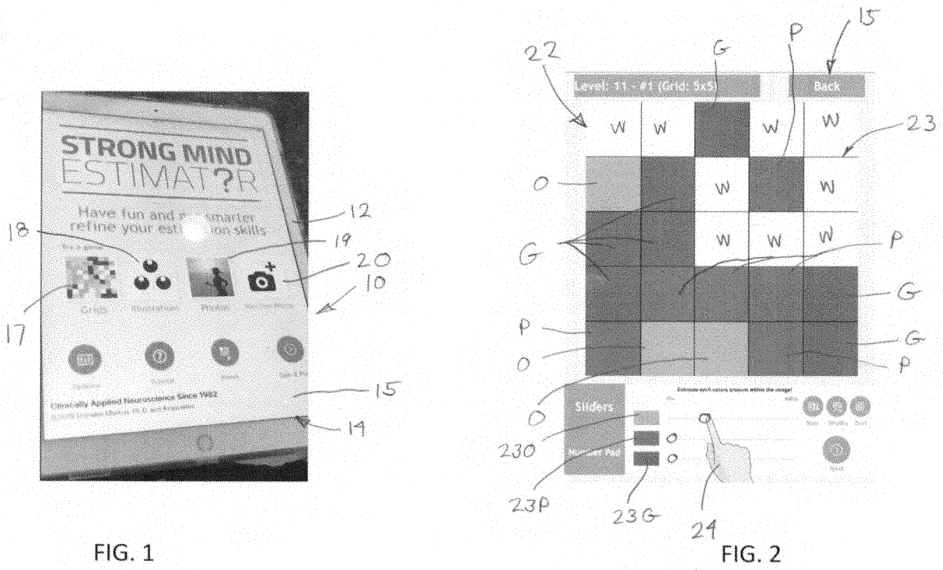

Referring to FIG. 1, the present invention relates to a method and system that incorporates a software-based visual estimator game for improving complex learning patterns, and more particularly to such system and method wherein the visual estimator game allows a user to repetitively rehearse numeric estimation of at least one aspect of the visual imagery to improve estimation skills and habituate complex learning processes.

FIG. 1 is a perspective view of a computing device 10 operating an estimator game or software application 12 on a visual display 14 which displays the GUI 15 (graphical user interface) of the present system. More particularly as to FIG. 1, the estimator game 10 is operated on any suitable computing device 12 such as a personal computer, notebook, smart phone or tablet or any other computing system including a processor, computer readable memory and the display 14 having the GUI 15 displayable thereon. It will be understood that the processor and associated memory are preferably located within the local computing system, although the associated processor and/or memory may be located remote from the display 14 such as a remote server accessed through a telecommunications network such as the internet by a browser or other suitable software application operating locally to access and display the estimator game. The computing system further includes an input means for entering data into the software game. In the preferred embodiment, the display 14 is a touch screen, and data entry is performed in a conventional manner by manual touching of the screen. As such, the input means may be the display 14 itself or a separate input device such as a mouse.

FIG. 1 displays the Home Page view for the estimator game, which operates as a main estimator module programmed to display multiple selector buttons to access different units or modules within the estimator game. The principal selector buttons in this Home Page view include buttons to access four preferred game modules labelled as Grids 17, Illustrations 18, Photos 19 and Your Own Photos 20. By hitting any button, the estimator game will execute process steps or code to initiate any of these individual modules 17-20.

Generally as to each unit 17-20, the computing device 10 includes a store of multiple different images which may be grouped in one or more image types such as Grids 17, Illustrations 18 and Photos 19, which typically are preloaded photos resident in the estimator game during original installation or updating of the software, and Your Own Photos 20, which typically are personal images uploaded or captured by the user to the estimator game and saved to the storage media thereof. Each image type has one or more visual aspects or characteristics which can be visually recognized and numerically quantified by the computing system such as by determining a numerical magnitude for the visual aspect. For example, the images may be color photos and the visual aspects may be defined by different colors. Or the images may be black and white or grayscale and the visual aspects may be black or white, or some readily discernible shade of gray. Each of the colors may cover an area having a magnitude which may be numerically quantified, such as an area percentage covered by a color in comparison to a total area of the image, or the proportion or ratio of a number of units or blocks of such color in comparison to the total number of units or blocks making up the image.

As described herein, the computing system includes several operating modes selected by buttons 17-20 which will access the particular image type associated with that operating mode or unit. Upon selection of any desired button 17-20, the computing system 10 will generate a subset of visual images, i.e. an image set selected from the folder or database of images associated with the processor, and then visually display the set of selected images, one at a time, to a user for analysis and estimation of the selected visual aspect(s) as described further below. It will be understood that the processor may be used to select such images, and the set of images may be preselected as a group prior to the entry of estimation data, and then displayed one at a time, or the computing system and processor may randomly select an image one at a time just prior to displaying such image for entry of estimation data. Preferably, the user cannot preview the images selected for display, although the user may use their own photos which might result in some previewing of the images.

For each picture displayed to a user, the computing system will analyze a particular visual aspect of each image such as the percentage area of the image comprising a distinctive color, for example, the color black, in comparison to the total area of that visual image. The inventive process performs said analysis for each image and stores calculated image data resulting from such analysis in storage media for subsequent comparison with estimation data input by the user when playing the estimator game. The calculated image data is any type of image data suitable for estimation and may be determined in several ways including, but not limited to, percentages, proportions, ratios or relative sizes of a particular image aspect in comparison to a larger amount such as the image as a whole. Essentially, the calculated image data comprises quantifiable magnitudes that are suitable for estimation as described herein.

Preferably, the system includes a processor for analyzing each image relative to the visual aspect being evaluated to calculate the image data associated with that visual aspect. Depending upon the image type, the selected image would then be displayed by initiating a respective one of the operating units or modules by actuating one of the buttons comprising Grids 17, Illustrations 18, Photos 19 and Your Own Photos 20, which each functions as a separate module. Each module 17-20 allows the user to view and evaluate an image and subjectively enter a personal estimate associated with the visual aspect as described below. An estimate is entered by the user as estimation date to the computing system and processor thereof, and stored by the processor in an associated computer readable memory for subsequent analysis. The estimation process is then repeated for each image in the image set wherein the user enters estimation date or an estimate for each image of the set before the system provides determines results or performance feedback for the user. The system repeats the estimator procedure several times before providing performance feedback to the user, wherein the system displays feedback indicating the correctness of the estimate and/or degree of deviation of the personal estimate from the calculated image date for the visual aspect being estimated. Repetitive training with this estimator helps the user to habituate complex learning patterns.

Referring more particularly to FIG. 2, the Grids unit or module may be actuated such as by touching the Grids button 17, wherein FIG. 2 is an exemplary screenshot for the GUI 15 of the present system showing the Grids view. As the Grids module operates, a first visual image 22 of the Grids image type is displayed on the GUI. In FIG. 2, the Grids image is defined by blocks of different colors arranged in any combination such as five blocks in five rows, i.e. 5x5. Further, the complexity of the image may vary as the user progresses through multiple Levels with progressively increasing complexity being presented as the user works through each Level.

Also, the computing system 10 preferably displays the image with an overlying grid 23 such as the first grid configuration shown in FIG. 2. The grid 23 provides a visual indicator to the user that may provide some help in generating an estimate.

In this first image 22, the image 22 is presented with a unique visual pattern comprising multiple colors. Each color serves as a visual aspect that can be viewed by the user, wherein the user attempts to estimate the percentage of the total image area covered by each of the visual aspects, i.e. each of the colors. One or more visual aspects may be used. Specifically, this first image 22 is formed of three block colors green (G), orange (0) and purple (P). The background block color is presented in white (W) and ignored in the data entry step of the estimation process in this example, although the white blocks still factor in the impact of the process.

Once the image 22 is displayed, the user is tasked with estimating the percentage of area covered by each of the visual aspects, i.e. green, orange and purple blocks, in comparison to the total area of the image 22. The estimator game includes a means or data entry feature for inputting estimation data into the computing system. In one example, the GUI 15 includes three sliders 230 (orange), 23P (purple) and 23G (green), which can be touched by the user 24 as seen in FIG. 2 to enter an area estimate.

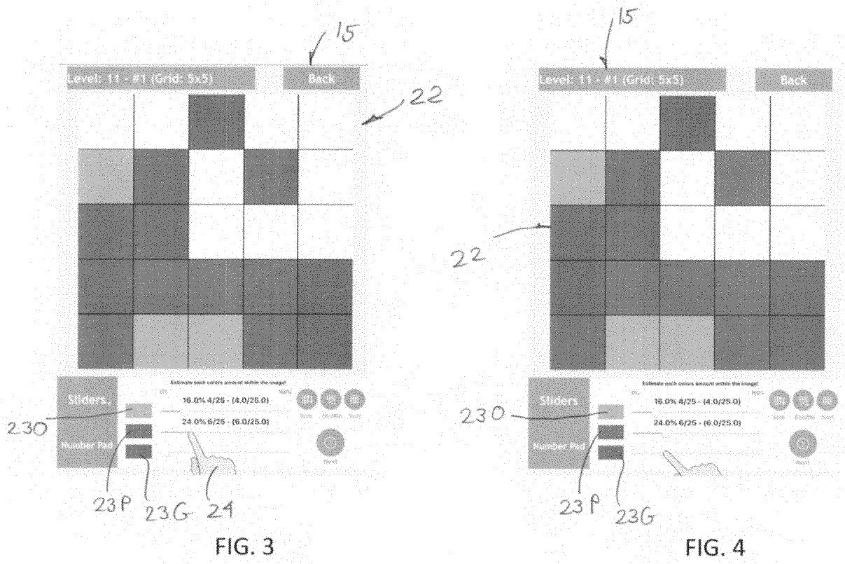

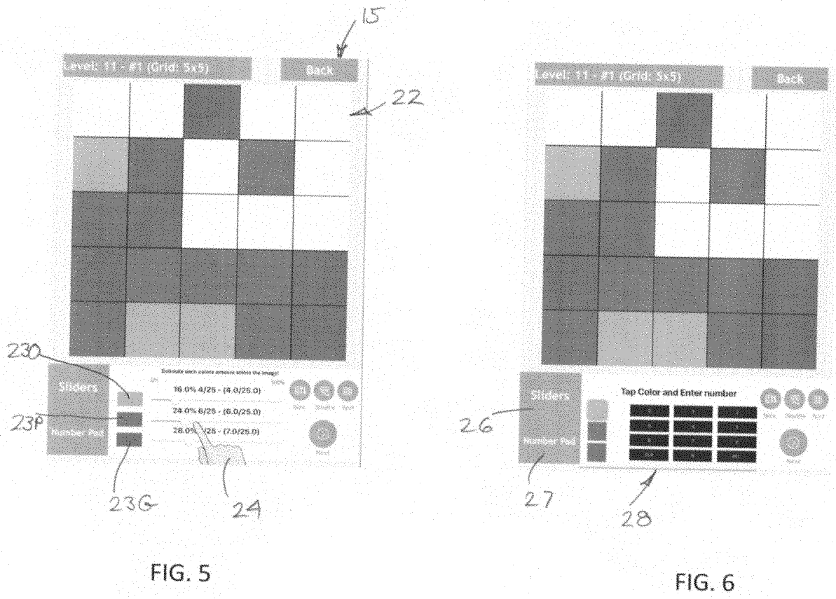

FIG. 3 is an exemplary screenshot for the GUI 15 of the present system showing the user 24 entering estimation data for the slider 230, which already has been entered as 16.0%, and the slider 23P, which has just been completed by the user 24 at 24.0%. FIG. 4 shows the user 24 moving the slider 23G and FIG. 5 shows the user entering the estimation data for green blocks G as 25.0% using slider 23G. Notably, each of the sliders 230, 23P and 23G show the percentage estimate and also may show the estimate in terms of a proportion or ratio of blocks, i.e. 4 green blocks out of a total of 25 blocks is shown as (4.0/25.0).

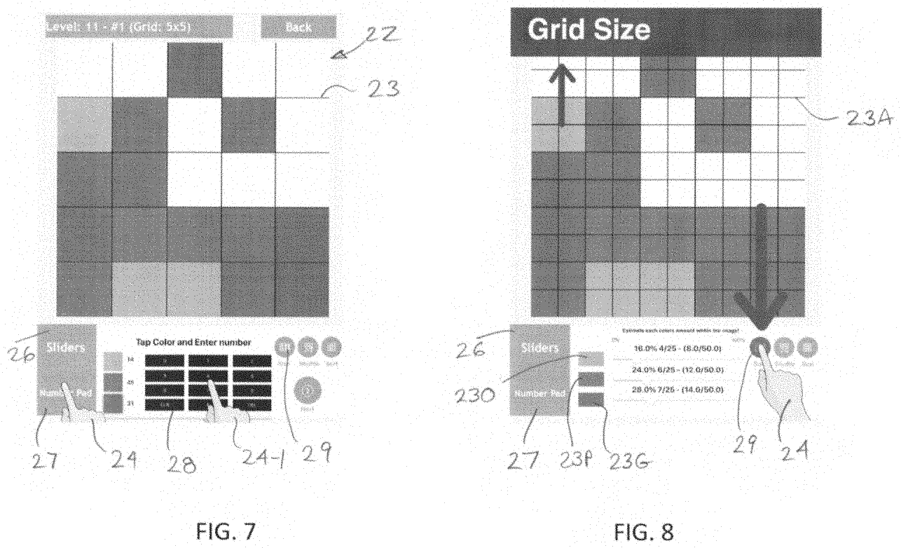

Referring to FIGS. 6 and 7, the data entry method or feature for entering estimation data may also be toggled to a numeric keypad for direct data entry instead of the sliders 23O, 23P and 23G. Specifically, the GUI 15 includes a Sliders button 26 and a Number Pad button 27, which allows selection of either data entry method. When the Number Pad button 27 is selected, the number pad 28 is displayed as the data entry feature instead of sliders, which allows numeric entry of the estimation data. The color indicators 23O, 23P and 23G now function as selector buttons that allow the numeric data to be entered by the number pad 28, the color tapped, and the next estimation data entered by the number pad 28.

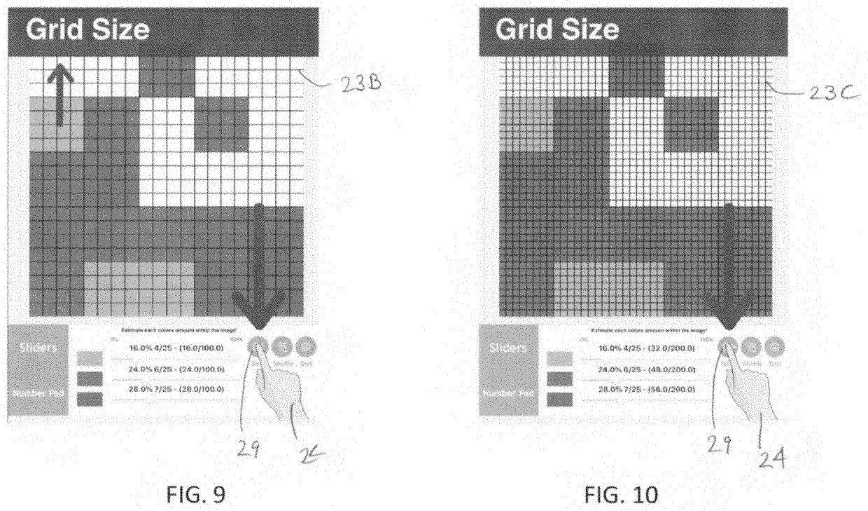

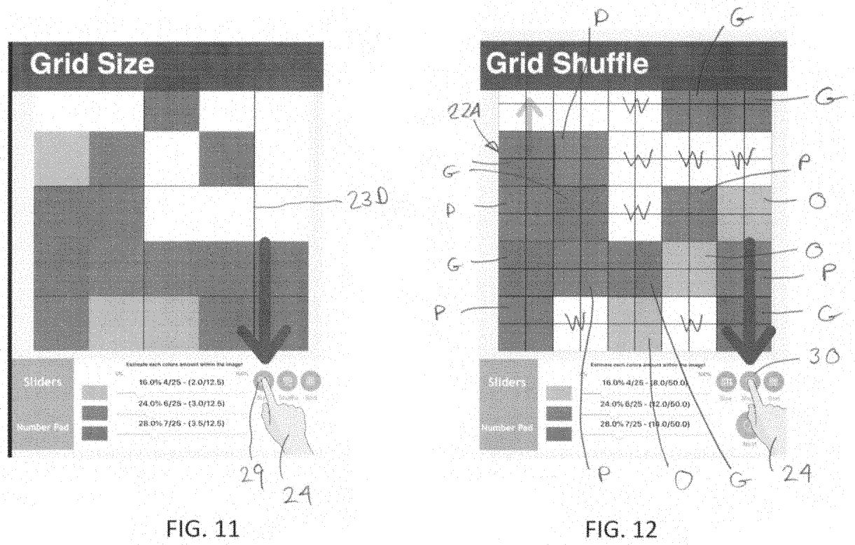

During this estimation phase, the user has several different options to reconfigure the display and attempt to better estimate the visual aspects being displayed for the image 22. First, the user may vary the grid size by a Size button 29, which can be manually tapped by the user 24 to vary the size of the grid 23. For example, FIG. 8 shows changing of the grid configuration to a second grid configuration 23A. Similarly, FIGS. 9-11 shows changing or toggling of the grid configuration to grid sizes 23B (FIG. 9), 23C (FIG. 10), and 23D (FIG. 11). Notably, the grid configuration can comprise horizontal and vertical lines that define grid squares that are small or larger than an individual color block W, G, P or O.

Next as to FIG. 12, an image or grid Shuffle button 30 is also provided to change the image 22. Notably, the image 22 has the color blocks W, G, P and 0 in a first pattern. In FIG. 12, the Shuffle button 30 shuffles the arrangement of the color blocks to form a new image pattern 22A. This shuffled image pattern 22A includes the same number of color blocks W, G, P and O as in image 22 except that the pattern is rearranged to further challenge the user to calculate similar area estimates despite the change in pattern. While the arrangement is reconfigured, this still represents one image for purposes of the image set.

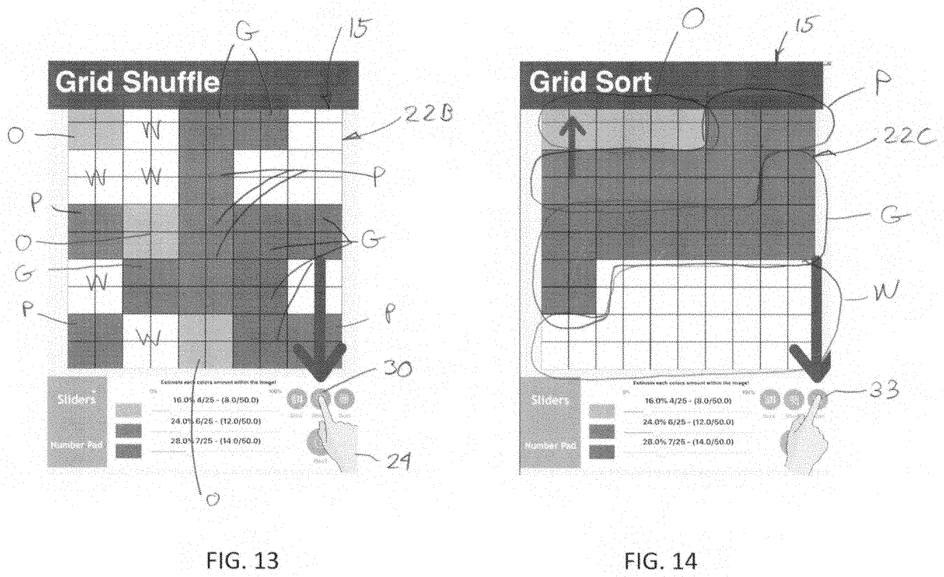

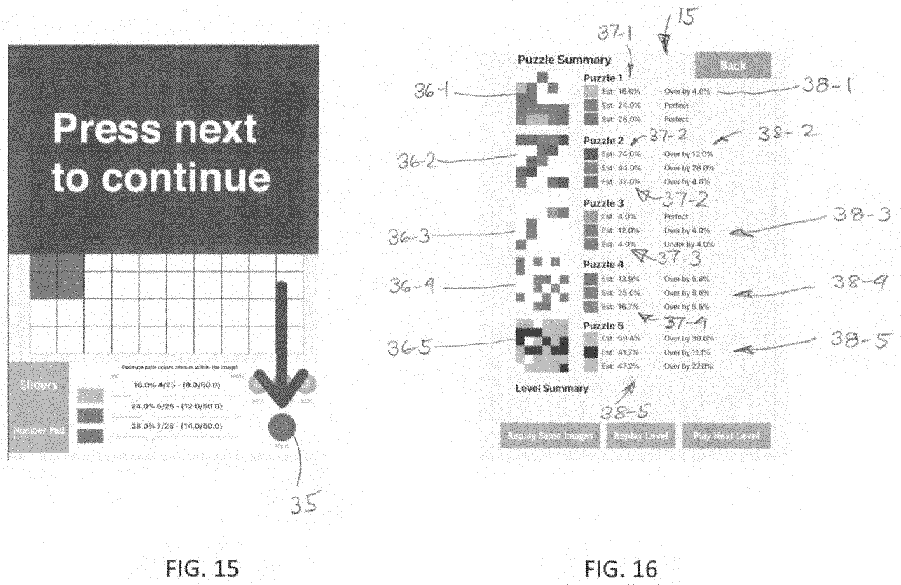

FIG. 13 shows the second image configuration 22A shuffled to a third image configuration 22B while retaining the same quantity of color blocks W, G, P and O and the same percentage of area covered by each color. To further alter the image arrangement, a Sort button 33 is provided in FIG. 14, which may be tapped to sort and group the color blocks W, G, P and O together by their respective colors to form another variation of the image pattern 22. All of these image patterns 22, 22A, 22B and 22C still use the same number of color blocks such that the area percentages do not change. Further, the grid configurations do not change the underlying image 22. These features or options allow the user 24 to better develop their estimation skills.

Once the estimation date is entered through the sliders or number pad, the user 24 hits the Next button 35 to complete data entry for this particular image 22. At this time, the estimator game presents another, different image and the estimation process is again performed by the user until multiple images have been completed. As noted above, the system repeats the estimator procedure several times as the user works through all of the images of the image set before providing performance feedback to the user.

In this example, five visual images are completed as part of the image set before results or feedback is displayed. FIG. 16 is another exemplary screenshot for the GUI 15 of the present system showing the Puzzle Summary or Results view after completion of data entry for each image in the image set which are displayed as Puzzles 1-5. As can be seen, five images 36-1 through 36-5 are shown alongside feedback comprising the estimation data 37-1 through 37-5 entered by the user, and comparative results data 38-1 through 38-5 generated or calculated by the processor of the computing device. This feedback indicates the correctness of the estimate and/or degree of deviation of the personal estimate or estimation date from the calculated image data for the visual aspect being estimated. In the illustrated example, the comparative results data is calculated as the percentage difference that the estimation data entered by the user is higher than or lower than the calculated image data. For example, the percentage difference that the estimation data is higher or lower than the magnitude of the actual image data. As described above, repetitive training with this estimator helps the user to analyze their errors and habituate complex learning patterns.

Depending upon whether the user is satisfied with the results, the user may replay same images, replay the level, or move on and play the next level of images.

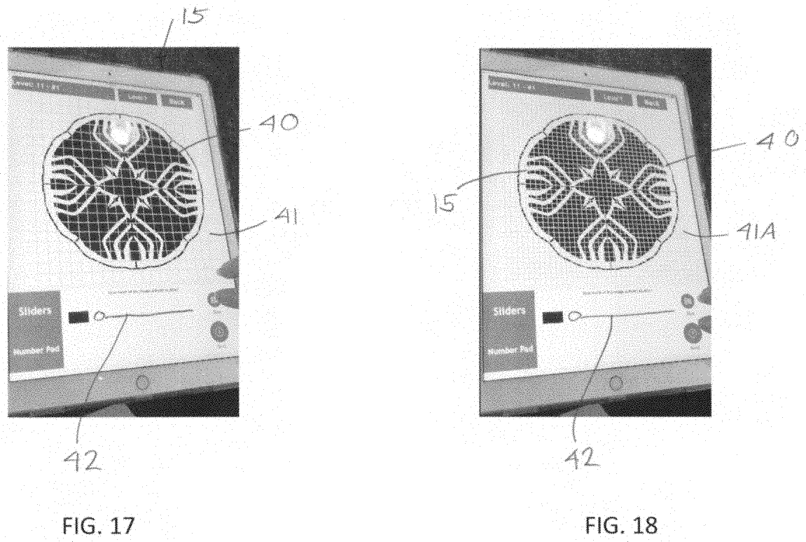

As described above relative to FIG. 1, the estimator game includes options to play multiple modules or units. For example, for increased complexity, the user may instead select the Illustrations button 18, which will use stored images having a different type as seen in FIGS. 17-19. FIG. 17 is an exemplary screenshot for the GUI 15 of the present system showing the Illustrations view with a first visual image 40 from this Illustrations image type having a first grid configuration 41 displayed thereon. FIG. 18 is an exemplary screenshot for the GUI 15 of the present system showing the Illustrations view with the first visual image 40 from this image type having a second grid configuration 41A displayed thereon. This grid display corresponds to the above description of this feature, and further discussion is not required.

In FIGS. 17 and 18, the image 40 is in black and white and the slider 42 only requires estimation of the percentage of black in the image 40 in comparison to the remaining portion in white. In this image 40, the visual aspect, i.e. black color, covers a majority of the image area. While the number of visual aspects is reduced to only one color selection, the image 40 is much more complex in comparison to the Grids images discussed above, which increases the complexity of making an estimate.

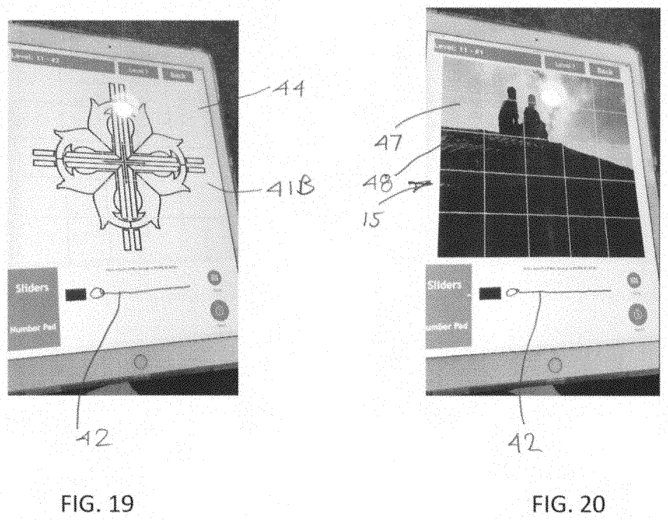

FIG. 19 is an exemplary screenshot for the GUI 15 of the present system showing the Illustrations view with the first visual image 40 changed to a second visual image 44 from this Illustrations image type having a third grid configuration 41B displayed thereon. In this image 44, the black area is reduced, and the user still must estimate the area coverage of the black color with slider 42. While shown in black and white, any color combination can be used.

Next, FIG. 20 is an exemplary screenshot for the GUI 15 of the present system showing the Photos view with a first visual image 47 from this Photos image type having the first grid configuration 48 displayed thereon. As described above relative to FIG. 1, the estimator game includes options to play these multiple modules or units. As such, the user may select the Photos button 19, which will use stored images having the different Photos image type as seen in FIG. 20.

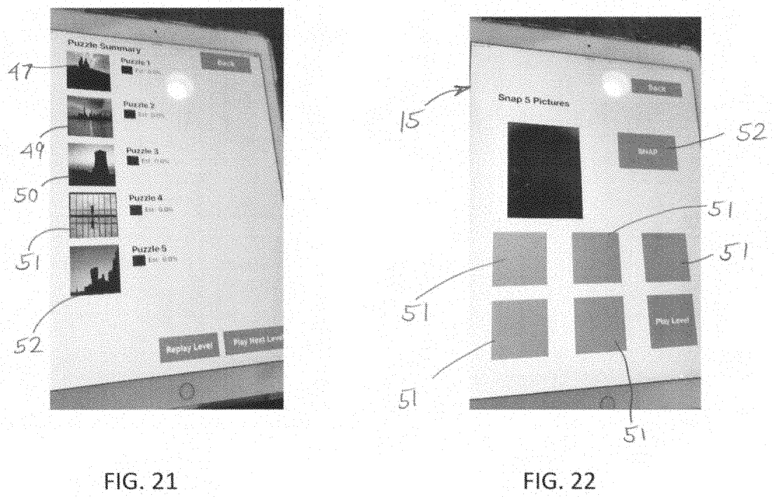

Here again in FIG. 20, the image 47 is in black and white and the slider 42 only requires estimation of the percentage of black in the image 47 in comparison to the remaining portion in white. In this image 47, the visual aspect, i.e. black color, covers a majority of the image area. As seen in the Results view of FIG. 21, the five images 47, 49, 50, 51 and 52 are all different but presented in black and shades of gray wherein the user is views more complex pictures to estimate the black portion thereof. It is within the scope of the invention to use different shades of color other than black and require estimation of the different colors.

Next, FIG. 22 is an exemplary screenshot for the GUI 15 of the present system showing the selection screen accessed by the Your Own Photos button 20. In this embodiment, the user can choose the image to be played by viewing or searching photos or pictures existed in the computing device. In another embodiment, the user can take a digital photograph by a camera connected to the computing device. Additionally the user can edit the settings (e.g., sound, music, background color) through GUI. These images can be stored for use by the estimator game. In more detail, the available images can be displayed in image slots 51 and uploaded or obtained directly by the snap button 52 which can be used to trigger the computer's internal camera to capture and store the images. The processor can then analyze these user-obtained photos and identify selected visual aspects that would then be presented to the user for estimation in the same manner as described above relative to the Photos module.

The system and process of the present invention provides significant advantages in enhancing complex processing skills. In effect, the estimator program incorporates the rehearsal of visual imagery analysis, which ultimately habituates estimation skills to everyday living. Rehearsal builds habituation, or in other words, repetition of skills, particularly when they become increasingly more challenging helps to build improved processing habits. At its most basic level, the estimation game teaches the user to identify the relationship of part-to-whole, which translates into improved estimation skills. In a larger sense, these improved skills improve the development of metacognitive thinking and problem-solving skills. Further, randomized selection of images by the system and presentation of the images with a variety of visual modifiers such as different sized grids provides thousands of different opportunities to rehearse estimating at different skill levels, i.e. beginning intermediate, advanced and expert.

Although particular preferred embodiments of the invention has been disclosed in detail for illustrative purposes, it will be recognized that variations or modifications of the disclosed apparatus, including the rearrangement of parts, lie within the scope of the present invention.

1. A method for developing cognitive skills of a user with an estimator game on a computing device comprising:
storing a plurality of visual images on the computing device, each of said images exhibiting a plurality of different image aspects, wherein each of said image aspects of each said image has an actual magnitude associated therewith that is quantifiable and storable as actual image data;
selecting a subset of images to form an image set;
displaying each of said images of said image set one at a time on a graphical user interface of said computing device;
displaying on said graphical user interface of the computing device a data input feature operable by a user to permit entry of estimation data for each of one or more of said image aspects associated with said displayed image;
entering an estimate of said actual image data with said data input feature operated by the user viewing said displayed image, which is entered as estimation data;
storing said estimation data entered by said user on said computing device for said displayed image; and
repeating said displaying step and said entering step for each of said images in said image set;
generating performance results by comparing said estimation data with said actual image data and determining comparative results data for each said image of said image set; and
after said storing of said estimation data for all of said images of said image set, displaying said performance results on said graphical user interface for all of images of said image set for evaluation by the user.

2. The method of claim 1, wherein said comparative results data indicates a numerical deviation between the estimation data and said actual image data.

3. The method of claim 1, wherein said comparative results data is expressed as a percentage on said graphical user interface for each said image with said performance results for all of said images of said image set being displayed together.

4. The method of claim 1, wherein said magnitude of said actual image data is calculated as a portion of total area covered by each said visual aspect.

5. The method of claim 4, wherein said actual image data is calculated as at least one of a percentage of total area or a proportion of the total area covered by said visual aspect.

6. The method of claim 1, wherein each said visual aspect relates to a color different from a color of any other visual aspect.

7. The method of claim 1, wherein said images are stored in groups of two or more image types, wherein said method includes the step of selecting one of said image types performed before said step of said selecting of said subset, wherein said images of said subset are all of said selected image type.

8. The method of claim 7, wherein said image types comprises block images defined by multi-color blocks, illustrations illustrating an image comprised of at least two different colors, and photos stored on said computing device and comprised of multiple colors.

9. The method of claim 1, further including the step of generating calculated data by said computing device for each said image by analyzing said images with said computing device to determine said actual image data for each of said visual aspects of each said image stored in said computing device.

10. The method of claim 1, wherein said data entry feature is one of a slider and a number pad by which said estimation data is entered numerically by said user.

11. A software program for developing cognitive skills of a user with an estimator game on a computing device comprising:
a computing device having a processor and data storage on which said software program is stored and operated to perform said estimator game, said computing device including a display on which is displayed a graphical user interface, said estimator game operable on said computing device to perform the steps of:
storing a plurality of visual images on said computing device, each of said images exhibiting a plurality of different image aspects, wherein each of said image aspects of each said image has an actual magnitude associated therewith that is quantifiable and storable as actual image data;
said estimator game being operated by said computing device to select a subset of images to form an image set upon initiation of said estimator game;
displaying each of said images of said image set one at a time on said graphical user interface of said computing device;
displaying on said graphical user interface of the computing device a data input feature operable by the user to permit entry of estimation data for each of one or more of said image aspects associated with said displayed image;
entering an estimate of said actual image data with said data input feature operated by the user viewing said displayed image, which is entered as estimation data;
said computing device being operated to store said estimation data entered by said user for said displayed image; and
repeating said displaying step and said entering step for each of said images in said image set;
said computing device generating performance results by comparing said estimation data with said actual image data and determining comparative results data for each said image of said image set; and
after said storing of said estimation data for all of said images of said image set, displaying said performance results on said graphical user interface for all of said images of said image set for evaluation by the user.

12. The method of claim 11, wherein said comparative results data indicates a numerical deviation between the estimation data and said actual image data.

13. The method of claim 11, wherein computing device calculates said comparative results data as a percentage for each said image with said performance results for all of said images of said image set being displayed together.

14. The method of claim 11, wherein said magnitude of said actual image data is calculated by said computing device as a portion of total area covered by each said visual aspect.

15. The method of claim 14, wherein said actual image data is calculated as at least one of a percentage of total area or a proportion of the total area covered by said visual aspect.

16. The method of claim 11, wherein each said visual aspect relates to a color different from a color of any other visual aspect.

17. The method of claim 11, wherein said processor stores said images in groups of two or more image types, wherein said estimator game displays a selection tool on said graphical user interface by which said user selects one of said image types performed before said step of said selecting of said subset, wherein said images of said subset are all of said selected image type.

18. The method of claim 17, wherein said image types comprises block images defined by multi-color blocks, illustrations illustrating an image comprised of at least two different colors, and photos stored on said computing device and comprised of multiple colors.

19. The method of claim 11, wherein said processor is operated to generate calculated data for each said image by analyzing said images with said computing device to determine said actual image data for each of said visual aspects of each said image stored in said computing device.

20. The method of claim 11, wherein said data entry feature is one of a slider and a number pad by which said estimation data is entered numerically by said user on said graphical user interface.
